(19) United States
(12) Patent Application Publication
(10) Pub. No.: US 2026/0170885 A1
(43) Pub. Date: Jun. 18, 2026

(54) METHOD AND APPARATUS FOR PROVIDING VEHICLE INFORMATION, AND VEHICLE SYSTEM INCLUDING SAME

(71) Applicants: HYUNDAI MOTOR COMPANY, Seoul (KR); KIA CORPORATION, Seoul (KR); INHA UNIVERSITY RESEARCH AND BUSINESS FOUNDATION, Incheon (KR)

(72) Inventors: Dae Kwang Kim, Hwaseong-si (KR); Min Soo Woo, Hwaseong-si (KR); Seung Jun Yoo, Incheon (KR); Byung Wook Kim, Seongnam-si (KR); Min Woo Gwon, Daejeon (KR); Kwang Ki Kim, Incheon (KR); Ji Won Kim, Incheon (KR)

(73) Assignees: HYUNDAI MOTOR COMPANY, Seoul (KR); KIA CORPORATION, Seoul (KR); INHA UNIVERSITY RESEARCH AND BUSINESS FOUNDATION, Incheon (KR)

(21) Appl. No.: 19/201,197

(22) Filed: May 7, 2025

(30) Foreign Application Priority Data
Dec. 18, 2024 (KR) 10-2024-0190127

(51) Int. Cl. G07C 5/02; B60L 58/12

(52) U.S. Cl. CPC G07C 5/02; B60L 58/12

(57) ABSTRACT

A method of providing information for a vehicle is performed by a computing device including a processor and a storage medium storing instructions executable by the processor. The method includes receiving destination information of the vehicle and target State Of Charge (SoC) information of a battery at a destination included in the vehicle, collecting driving environment data on a driving route determined based on the destination information, determining a charging plan establishment condition based on the target SoC information and the driving environment data, and generating charging plan information using a charging plan model based on an objective function when the charging plan establishment condition is satisfied.

### CROSS-REFERENCE TO RELATED APPLICATION(S)

This application claims benefit of and priority to Korean Patent Application No. 10-2024-0190127 filed on Dec. 18, 2024 in the Korean Intellectual Property Office, the disclosure of which is incorporated herein by reference in its entirety.

### TECHNICAL FIELD

The present disclosure relates to a method and apparatus for providing information for a vehicle, and a vehicle system including the apparatus or performing the method.

### BACKGROUND

Recently, a lot of development has been conducted on electric vehicles (EVs) or hybrid electric vehicles (HEVs) including batteries and electric motors.

The charging/discharging efficiency of a battery included in a vehicle may be different for each battery due to unique properties of the battery, and may also vary, depending on a state of charge (SoC) of the battery.

When travelling on a route farther than a distance to empty (DTE) of a battery of a vehicle, it may be necessary to charge the battery at a charging station located on the travel route.

In the related art, a relatively long period of time may be required to charge a battery, and therefore there may be difficulties in that a user may need to unnecessarily waste a long period of time during charging time or to select a charging station by searching for a location of a proper charging station, separately from a travel route.

### SUMMARY

An aspect of the present disclosure is to provide a method and apparatus for providing information for a vehicle, and a vehicle system including the apparatus or performing the method, which may generate and provide optimized charging plan information using an objective function-based charging plan model to improve user convenience and energy consumption efficiency.

An aspect of the present disclosure is to provide a method and apparatus for providing information for a vehicle, and a vehicle system including the apparatus or performing the method, which may shorten the charging time and driving time and improve the usability and management efficiency of a battery by generating and providing optimized charging plan information using an objective function-based charging plan model to a user.

An aspect of the present disclosure is to provide a method and apparatus for providing information for a vehicle, and a vehicle system including the apparatus or performing the method, which may provide personalized charging plan information to a user.

An aspect of the present disclosure is to provide a method and apparatus for providing information for a vehicle, and a vehicle system including the apparatus or performing the method, which may improve driving convenience and improve the overall road environment by generating and providing optimized charging plan information based on real-time traffic conditions and driving environment data.

According to an aspect of the present disclosure, the following method and apparatus for providing information for a vehicle and a vehicle system including the apparatus or performing the method are provided.

According to an aspect of the present disclosure, a method of providing information for a vehicle is performed by a computing device including a processor and a storage medium storing instructions executable by the processor. The method includes receiving destination information of the vehicle and target State Of Charge (SoC) information of a battery included in the vehicle at a destination, collecting driving environment data on a driving route determined based on the destination information, determining a charging plan establishment condition based on the target SoC information and the driving environment data, and generating charging plan information using a charging plan model based on an objective function when or based on that the charging plan establishment condition is satisfied.

According to an aspect of the present disclosure, an apparatus for providing information for a vehicle includes a processor and a storage medium storing instructions executable by the processor. The processor is configured to execute the instructions and, by executing the instructions, is configured to: receive destination information of the vehicle and target SoC information of a battery included in the vehicle at a destination; collect driving environment data on a driving route determined based on the destination information; determine a charging plan establishment condition based on the target SoC information and the driving environment data; and generate charging plan information using a charging plan model based on an objective function when or based on that the charging plan establishment condition is satisfied.

According to an aspect of the present disclosure, a vehicle system includes a battery, a display, an input module, and a processor. The processor is configured to display (or cause to display) a user interface for receiving destination information of a vehicle and target SoC information of the battery at a destination through the display, collect driving environment data on a driving route determined based on the destination information, determine charging plan establishment conditions based on the target SoC information and the driving environment data, generate charging plan information using a charging plan model based on an objective function when or based on that the charging plan establishment conditions are satisfied, and display (or cause to display) the charging plan information.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a block diagram of a vehicle system according to an embodiment;

FIG. 2 is a flowchart of a method of providing information for a vehicle according to an embodiment;

FIG. 3 is an example diagram illustrating a method of calculating energy consumption during vehicle driving in a method of providing information for a vehicle according to an embodiment;

FIG. 4 is an example diagram illustrating a method of generating charging plan information for a driving route in a method of providing information for a vehicle according to an embodiment;

FIG. 5 is an example diagram illustrating a method of generating charging plan information for a driving route in a method of providing information for a vehicle according to an embodiment;

FIG. 6 is an example diagram illustrating a method of generating charging plan information for a driving route in a method of providing information for a vehicle according to an embodiment;

FIG. 7A illustrates an example screen on which charging plan information generated by a method of providing information for a vehicle according to an embodiment is provided;

FIG. 7B illustrates an example screen on which charging plan information generated by a method of providing information for a vehicle according to an embodiment is provided; and

FIG. 8 is a block diagram of a computing device that may fully or partially implement a vehicle system according to an embodiment.

### DETAILED DESCRIPTION

Hereinafter, embodiments are described with reference to the drawings. The following detailed description is provided to help a comprehensive understanding of the methods, devices, and/or systems described in the present disclosure. However, this is merely an example and the present disclosure is not limited thereto.

In describing embodiments, if it is determined that a detailed description of known technologies related to the present disclosure may unnecessarily obscure the gist of the present disclosure, the detailed description thereof has been omitted. In addition, the terms described below are terms defined in consideration of their functions in the present disclosure and may vary depending on the intention or custom of the user or operator. Therefore, the definitions should be made based on the contents throughout the present disclosure. The terms used in the detailed description are only for the purpose of describing embodiments and should never be limited. Unless clearly used otherwise, expressions in the singular form include plural meanings. In this description, expressions such as “including,” “having,” or “provided” are intended to indicate certain features, numbers, steps, operations, elements, parts or combinations thereof, and should not be construed to exclude the presence or possibility of one or more other features, numbers, steps, operations, elements, parts or combinations thereof other than those described.

In addition, throughout the present disclosure, when a part is said to be “connected” to another part, this includes not only cases where it is “directly connected” but also cases where it is “indirectly connected” with other elements therebetween. The terms such as ‘unit’, ‘module’, and the like refer to one or more units for processing at least one function or operation, which may be implemented by hardware, software, or a combination thereof. When a component, processor, controller, device, element, unit, apparatus, or the like of the present disclosure is described as having a purpose or performing an operation, function, or the like, the component, processor, controller, device, element, unit, apparatus, or the like should be considered herein as being “configured to” meet that purpose or to perform that operation or function. Each controller, unit, module, component, device, element, and the like may separately embody or be included with a processor and a memory, such as a non-transitory computer readable media, as part of the apparatus. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

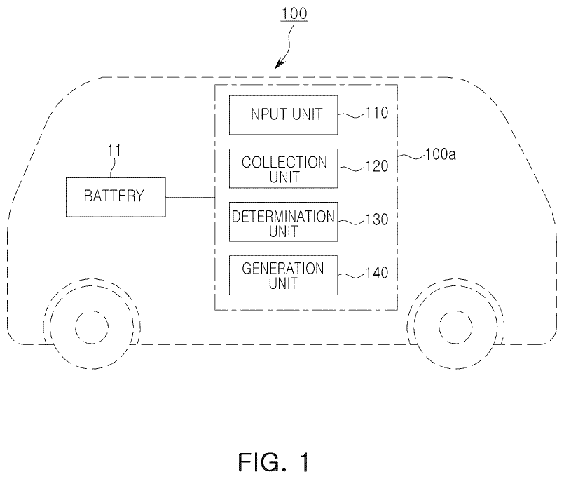

FIG. 1 schematically illustrates a vehicle system according to an embodiment. Referring to FIG. 1, a vehicle system 100 may include a battery 11 and an apparatus 100a for providing information for a vehicle. The apparatus 100a for providing information for a vehicle may include an input unit 110, a collection unit 120, a determination unit 130, and a generation unit 140.

A vehicle including the vehicle system 100 may be a hybrid vehicle or an electric vehicle that drives a motor using power supplied from the battery 11.

In addition, the battery 11 may supply power to other components included in the vehicle or the vehicle system 100. For example, the battery 11 may supply power to and operate a display, an input module, a communication module, a sensor module, a memory, and a processor included in the vehicle or the vehicle system 100.

The battery 11 included in the vehicle or the vehicle system 100 may include a rechargeable or dischargeable secondary battery. The State of Charge (SoC) of the battery 11 may be increased by charging or consumed or decreased by use.

The display included in the vehicle or the vehicle system 100 may display various data or content. For example, the display may display a user interface that receives destination information of the vehicle and target SoC information of the battery 11 at the destination (i.e., the target SoC of the battery 11 when the vehicle reaches the destination).

In addition, the display may display charging plan information. The charging plan information may include a charging station to perform charging among one or more charging stations located on the driving route, a charging amount, and a charging time.

The input module included in the vehicle or the vehicle system 100 may receive or detect a user input. For example, the input module may detect a user input based on at least one of a user's touch operation, a user's motion, or a user's voice.

The communication module included in the vehicle or the vehicle system 100 may communicate with an external device in a wired or wireless manner. For example, the communication module may collect driving environment data using Vehicle to X (V2X) communication.

The sensor module may detect the state of the vehicle and the external environment. For example, the sensor module may include at least one of a wheel speed sensor that detects the speed of the vehicle's wheels, a vehicle speed sensor that detects the driving speed of the vehicle, an accelerator pedal position sensor (APS) that is linked to the operation of the accelerator pedal, a brake pedal sensor (BPS) that is linked to the operation of the brake pedal, a steering angle sensor (SAS) that is linked to the operation of the steering wheel, a temperature sensor that detects the temperature inside or outside the vehicle, an image sensor that acquires image data inside or outside the vehicle, or a distance sensor that measures the distance from the vehicle to an obstacle located in one direction.

The memory may store data for providing a user interface and charging plan information.

The processor may control the operation of other components included in the vehicle or the vehicle system 100. For example, the processor may control at least one of a battery, a display, an input module, a communication module, a sensor module, or a memory.

Referring to FIG. 1, the input unit 110 may receive destination information of the vehicle and target SoC information of the battery 11 of the vehicle at the destination.

The destination information may include location information of the driving destination. The destination information may be determined based on at least one of location information of a location input by the user, location information of a location selected by the user through a search, location information of a location selected from a list of locations stored in the memory, or location information of a location received from an external device.

The target SoC information may indicate the SoC of the battery 11 desired by the user when the vehicle reaches the destination. For example, the user may input the target SoC as 50%. In another example, the user may input the target SoC as 85%.

The collection unit 120 may collect driving environment data on the driving route determined based on the destination information. The collection unit 120 may collect driving environment data using, for example, V2X communication.

The determination unit 130 may determine a charging plan establishment condition based on the target SoC information and the driving environment data. The charging plan establishment condition may include multiple sub-conditions. For example, the charging plan establishment condition may include a first sub-condition, a second sub-condition, and a third sub-condition.

The determination unit 130 may determine the first sub-condition based on the total required charging amount while driving the driving route. For example, the determination unit 130 may determine that the first sub-condition is satisfied when the total required charging amount has a positive value.

The determination unit 130 may determine the second sub-condition based on the minimum SoC information of the battery 11. The determination unit 130 may determine that the second sub-condition is satisfied when the first expected SoC information of the battery 11 has a value greater than the minimum SoC information of the battery 11 when the vehicle drives the section between the starting point and one or more charging stations located on the driving route and the closest charging station from the starting point.

The determination unit 130 may determine the third sub-condition based on the target SoC information. The determination unit 130 may derive or determine the first expected SoC consumption for driving the section between the closest charging station and the destination among one or more charging stations located on the driving route of the vehicle, and may derive or determine the second expected SoC information based on the difference between the maximum SoC information of the battery 11 and the first expected SoC consumption. The determination unit 130 may determine that the third sub-condition is satisfied when the target SoC information has a value greater than the second expected SoC information.

The determination unit 130 may determine that the charging plan establishment condition is satisfied when the first sub-condition, the second sub-condition, and the third sub-condition are all satisfied.

The generation unit 140 may generate charging plan information for the driving route when the charging plan establishment condition is satisfied. The generation unit 140 may generate charging plan information using a charging plan model based on an objective function. The objective function of the charging plan model may be defined based on the collected driving environment data.

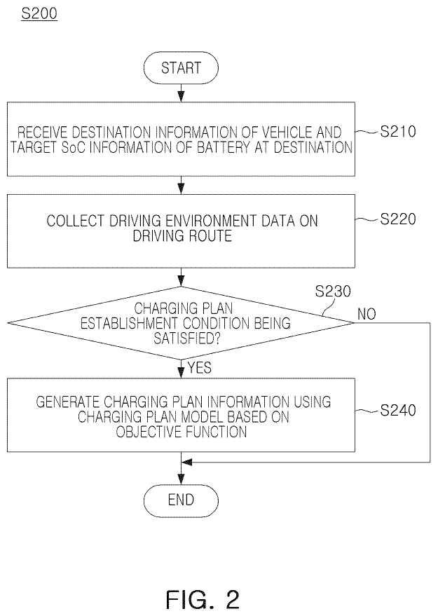

FIG. 2 is a flowchart of a method of providing information for a vehicle according to an embodiment. The method of providing information for a vehicle illustrated in FIG. 2 may be performed in whole or in part by the vehicle system 100 illustrated in FIG. 1.

Referring to FIG. 2, the method of providing information for a vehicle (S200) may include an operation of receiving destination information of the vehicle and target SOC (State of Charge) information of the battery of the vehicle at the destination (S210), an operation of collecting driving environment data on the driving route (S220), an operation of determining whether a charging plan establishment condition is satisfied (S230), and an operation of generating charging plan information using a charging plan model based on the objective function when the charging plan establishment condition is satisfied (S240).

In the operation (S210) of receiving destination information of the vehicle and target SoC information of the battery of the vehicle at the destination, destination information and target SoC information may be received from a user.

The destination information may include location information of the driving destination. The destination information may be determined based on at least one of, for example, location information of a place input by the user, location information of a place selected by the user through a search, location information of a place selected from a list of places stored in the memory, or location information of a place received from an external device.

The driving route is a route that may be driven from the starting point to the destination using the vehicle, and may be derived or determined based on the departure point information and the destination information. The departure point information may be set or determined by the current location of the vehicle or by user input.

If there are multiple driving routes that may be driven from the starting point to the destination, one of the driving routes may be selected by the user, or one of the driving routes may be selected according to a preset criterion.

The target SoC information may indicate the SoC of the battery desired by the user when the vehicle reaches the destination. The user may input the target SoC within a range of 0 to 100%. For example, the user may input the target SoC as 50%.

In the operation (S220) of collecting driving environment data on a driving route, driving environment data may be collected using V2X communication.

The driving environment data may include data on factors affecting energy consumed by the vehicle while the vehicle is driving along the driving path. The driving environment data may include, for example, at least one of the average driving speed of the driving path, the location of the charging station, the number and output of the charger, the availability of the charger, the road environment, the slope, the altitude, or the outside temperature. One or more charging stations may be located along the driving path.

In the operation (S230) of determining whether the charging plan establishment condition is satisfied, the charging plan establishment condition may be determined based on the target SoC information and the driving environment data.

The charging plan establishment condition may include a plurality of sub-conditions. For example, the charging plan establishment condition may include a first sub-condition, a second sub-condition, and a third sub-condition.

For example, the operation (S230) of determining whether the charging plan establishment condition is satisfied may include an operation of determining a first sub-condition based on the total required charging amount while driving along the driving path, an operation of determining a second sub-condition based on the minimum SoC information of the battery, and an operation of determining a third sub-condition based on the target SoC information.

The method of providing information for a vehicle (S200) may further include an operation of deriving or determining a total required charge amount for driving a driving path of the vehicle.

The operation of deriving or determining the total required charge amount may include an operation of deriving or determining an expected SoC consumption amount of one or more unit sections (i.e., segments, portions, lengths, and the like) included in the driving path and an operation of deriving or determining the total required charge amount based on target SoC information, a sum of the expected SoC consumption amounts of one or more unit sections, and initial SoC information of the battery.

The driving path may include a plurality of unit sections. For example, the driving path may include a plurality of unit sections separated by a constant distance interval.

In another example, the driving path may include a plurality of unit sections separated by a constant time interval.

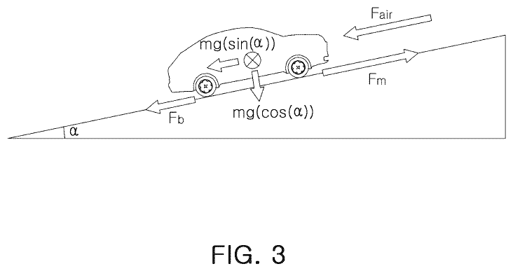

Hereinafter, a method of deriving or determining a total required charge amount is described in detail with reference to FIGS. 3-5.

FIG. 3 is an example drawing illustrating a method of calculating energy consumption when driving a vehicle. In FIG. 3, a is the slope of the unit section (i.e., slope of the road within the unit section), Fₘ is the wheel driving force of the unit section (i.e., wheel driving force of the vehicle within the unit section), F_{b} is the wheel braking force of the unit section (i.e., wheel braking force of the vehicle within the unit section), Fair is the air resistance, m is the mass of the vehicle, and g may mean the acceleration due to gravity.

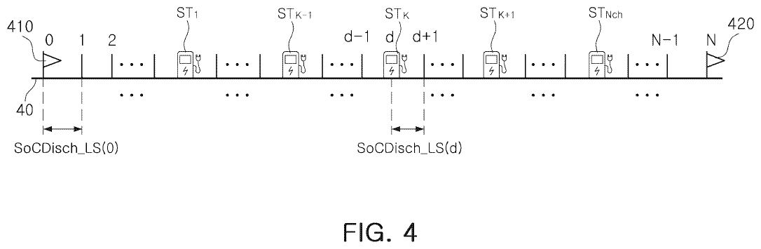

FIG. 4 schematically illustrates a driving path 40 determined based on a starting point 410 and a destination 420.

The driving path 40 may include a plurality of unit sections. In addition, one or more charging stations ST₁, . . . , STₖ₋₁, STₖ, STₖ₊₁, . . . , . . . and ST_{Nch} may be located on the driving path 40.

In the example illustrated in FIG. 4, the driving path 40 includes N unit sections, and N_{ch} charging stations are located on the driving path 40. For example, a starting point 410 may be located at unit section boundary number 0, a charging station (STₖ) may be located at unit section boundary number d, and a destination 420 may be located at unit section boundary number N.

The collected driving environment data may include average speed data of the vehicle in each unit section. For example, the driving environment data may include an average speed v(d) of the d-th unit section and an average speed v(d+1) of the (d+1)-th unit section.

The average speed v(d+1) of the (d+1)-th unit section may be expressed using mathematical expression 1.

$$v ( d + 1 ) = \sqrt{{v ( d )}^{2} + \frac{2 {L}_{s}}{{m}_{eq}} ( {F}_{m} ( d ) - {F}_{b} ( d ) - {F}_{r} ( d ) )} \qquad [ Mathematical expression 1 ]$$

In mathematical expression 1, v(d) is the average speed of the d-th unit section, Ls is the distance of the unit section, m_{eq} is the equivalent mass of the vehicle, Fₘ(d) is the wheel driving force of the d-th unit section, F_{b}(d) is the wheel braking force of the d-th unit section, and Fᵣ(d) may be the resistance of the d-th unit section.

The resistance (drag) of the d-th unit section, Fᵣ(d), may be expressed using mathematical expression 2.

$${F}_{r} ( d ) = \frac{1}{2} {ρ}_{a} {C}_{d} {A}_{f} {v ( d )}^{2} + {m}_{eq} g ( sin ( α ( d ) ) ) + {C}_{r} cos ( α ( d ) ) \qquad [ Mathematical expression 2 ]$$

In mathematical expression 2, ρ_{α} is the air density, C_{d} is the air resistance coefficient, A_{f} is the effective cross-sectional area of the vehicle, v(d) is the average speed of the d-th unit section, m_{eq} is the equivalent mass of the vehicle, g is the acceleration due to gravity, α(d) is the gradient of the d-th unit section, and Cᵣ may represent the rolling resistance coefficient.

According to mathematical expressions 1 and 2, the wheel driving force Fₘ(d) of the d-th unit section and the wheel braking force F_{b}(d) of the d-th unit section may be derived or determined.

The driving energy E_{trac}(d) required to drive the d-th unit section may be derived or determined using mathematical expression 3.

$${E}_{frac} ( d ) = \frac{{L}_{s}}{n ( d )} ( {F}_{m} ( d ) - {F}_{b} ( d ) ) v ( d ) \qquad [ Mathematical expression 3 ]$$

In mathematical expression 3, Ls is the distance of the unit section, n(d) is the motor driving efficiency of the d-th unit section, Fₘ(d) is the wheel driving force of the d-th unit section, F_{b}(d) is the wheel braking force of the d-th unit section, and v(d) may represent the average speed of the d-th unit section.

E_{consumption}(d), which is the driving energy consumption for driving the d-th unit section, may be derived or determined using mathematical expression 4.

$${E}_{consumption} ( d ) = {E}_{frac} ( d ) + {E}_{aux} ( d ) \qquad [ Mathematical expression 4 ]$$

In mathematical expression 4, E_{trac}(d) may represent the driving energy required to drive the d-th unit section, and Eₐᵤₓ(d) may represent the auxiliary energy required to drive the d-th unit section.

The auxiliary energy may mean other energy than the driving energy required to drive the motor to drive the unit section. The auxiliary energy may include energy used for other components other than the motor, such as the vehicle's thermal management device and air conditioning device.

SoCDisch_Ls(d) illustrated in FIG. 4 may mean the driving consumption SOC of the d-th unit section. SoCDisch_Ls(d) may be derived or determined using mathematical expression 5.

$$SoCDisch\_Ls ( d ) = \frac{{L}_{s}}{n ( d ) {E}_{cap}} ( {F}_{m} ( d ) - {F}_{b} ( d ) ) v ( d ) + \frac{{E}_{aux} ( d )}{{E}_{cap}} \qquad [ Mathematical expression 5 ]$$

In the mathematical expression 5, Lₛ is the distance of the unit section, n(d) is the motor driving efficiency of the d-th unit section, Fₘ(d) is the wheel driving force of the d-th unit section, F_{b}(d) is the wheel braking force of the d-th unit section, v(d) is the average speed of the d-th unit section, Eₐᵤₓ(d) is the auxiliary energy required to drive the d-th unit section, and E_{cap} may represent the battery capacity.

For example, SoCDisch_Ls(d) may be derived or determined as the value of E_{consumption}(d), which is the driving energy consumed for driving the d-th unit section, divided by the battery capacity.

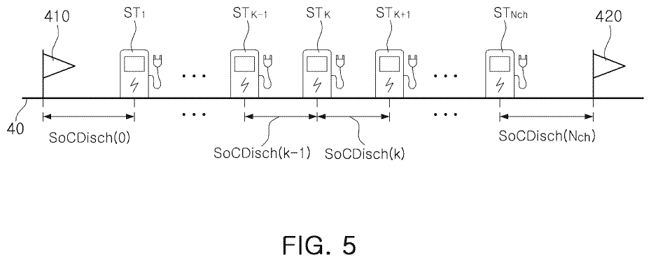

FIG. 5 illustrates a driving route 40 determined based on the starting point 410 and the destination 420 in FIG. 4, omitting the indication of the unit section, and one or more charging stations ST₁, . . . , STₖ₋₁, STₖ, STₖ₊₁, . . . , and ST_{Nch} located on the driving route 40.

In FIG. 5, SoCDisch(0) may represent the driving consumption SoC for driving the section from the starting point 410 to the charging station (ST₁) (i.e., the first charging station along the driving path from the starting point 410). SoCDisch(0) may be derived or determined as a value that adds the driving consumption SoC of the unit section included between the starting point 410 and the first charging station (ST₁).

In addition, SoCDisch(k) may represent the driving consumption SoC for driving the section from the k-th charging station (STₖ) to the (k+1)-th charging station (STₖ₊₁).

SoCDisch(k) may be derived or determined using mathematical expression 6.

$$SoCDisch ( k ) = {\sum }_{d = station \_ dist ( k )}^{station \_ dist ( k + 1 )} SoCDisch\_Ls ( d ) \qquad [ Mathematical expression 6 ]$$

In mathematical expression 6, station_dist(k) may represent the order of the unit section corresponding to the k-th charging station (STₖ), and station_dist(k+1) may represent the order of the unit section corresponding to the (k+1)-th charging station (STₖ₊₁).

For example, SoCDisch(k) may be derived or determined as a value that adds up the driving consumption SoC of the unit section included between the k-th charging station (STₖ) and the (k+1)-th charging station (STₖ₊₁).

However, SoCDisch(0) may represent the driving consumption SoC for driving the section from the starting point 410 to the first charging station (ST₁). SoCDisch(0) may be derived or determined as a value that adds up the driving consumption SoC of the unit section included between the starting point 410 and the first charging station (ST₁).

In addition, SoCDisch(N_{ch}) may represent the driving consumption SoC for driving the section from the Nch-th charging station (ST_{Nch}) to the destination 420. SoCDisch(Nch) may be derived or determined as a value that adds the driving consumption SoC of the unit section included between the Nch-th charging station (ST_{Nch}) and the destination 420.

The total required charging amount, SoCCh_{Total}, may be derived or determined using mathematical expression 7.

$${SoCCh}_{Total} = SoCFinal - ( SoCInitial - {\sum }_{j = 0}^{{N}_{ch}} SoCD isch ( j ) ) ) \qquad [ Mathematical expression 7 ]$$

In the mathematical expression 7, SoCFinal is the destination target SoC, SoCInitial is the initial SoC of the battery, SoCDisch(j) is the SoC value derived or determined using the mathematical expression 6, and Nch may be the number of charging stations located on the driving route.

Referring again to FIG. 2, in the operation (S230) of determining whether the charging plan establishment condition is satisfied in the method of providing information for a vehicle (S200), the operation of determining the first sub-condition included in the step may be determined to be satisfied when the total required charging amount has a positive value.

The method of providing information for a vehicle (S200) may further include the operation of deriving or determining the first expected SoC information of the battery.

The first expected SoC information may include the SoC prediction value of the battery when the vehicle drives the section between the starting point and one or more charging stations located on the driving route and the closest charging station from the starting point (i.e., the first charging station).

For example, in FIG. 5, the first expected SoC information may be a predicted SoC value of the battery when driving from the starting point 410 to the first charging station (ST₁).

When the initial SoC of the battery is SoCInitial and the driving consumption SoC for driving the section from the starting point 410 to the first charging station (ST₁) is SoCDisch(0), the first expected SoC information may be derived or determined as (SoCInitial−SoCDisch(0)).

The operation of determining the second sub-condition may determine that the second sub-condition is satisfied when the first expected SoC information has a value greater than the minimum SoC information of the battery.

The method of providing information for a vehicle (S200) may further include an operation of deriving or determining a first expected SoC consumption amount for driving the section between the charging station closest to the destination among one or more charging stations located on the driving route of the vehicle and the destination, and an operation of deriving or determining second expected SoC information based on a difference between the maximum SoC information of the battery and the first expected Soc consumption amount.

For example, in FIG. 5, the first expected SoC consumption may be the driving consumption SoC for driving from the Nch charging station (ST_{Nch}) to the destination 420.

When the maximum SoC of the battery is MaxSoC and the first expected SoC consumption is SoCDisch(Nch), the second expected SoC information may be derived or determined as (MaxSoC−SoCDisch(Nch)).

In the operation of determining the third sub-condition, it may be determined that the third sub-condition is satisfied when the target SoC information has a value greater than the second expected SoC information.

In the operation of determining whether the charging plan establishment condition is satisfied (S230), it may be determined that the charging plan establishment condition is satisfied when the first sub-condition, the second sub-condition, and the third sub-condition are all satisfied.

For example, in the operation (S230) of determining whether the charging plan establishment condition is satisfied, the charging plan establishment condition may be determined as being satisfied if the total required charging amount has a positive value, the first expected SoC information has a value greater than the minimum SoC information of the battery, and the target SoC information has a value greater than the second expected SoC information.

The method of providing information for a vehicle (S200) may proceed to the operation (S240) of generating charging plan information if the charging plan establishment condition is satisfied as a result of the determination of S230 (“YES” in S230).

If the charging plan establishment condition is not satisfied as a result of the determination of S230 (“NO” in S230), the method of providing information for a vehicle (S200) may be terminated.

In the operation (S240) of generating charging plan information, charging plan information for a driving route 40 may be generated using a charging plan model based on an objective function. The charging plan information may include, for example, a charging station to perform charging among one or more charging stations located on the driving route, a charging amount, and a charging time required.

The operation of generating charging plan information (S240) may include an operation of setting an objective function of a charging plan model based on driving environment data. For example, the driving environment data may include data on one or more charging stations located on a driving route.

The objective function of the charging plan model may be set or determined based on the total charging time and the total number of charging times while driving the driving route.

The operation of generating charging plan information (S240) may derive or determine the minimum solution (i.e., lowest or smallest value) of the objective function using the charging plan model, and generate charging plan information based on the minimum solution of the objective function.

The objective function of the charging plan model may be set, for example, as in the following mathematical expression 8.

$$J = {\sum }_{k = 1}^{{N}_{ch}} {τ}_{ch} ( k ) + ω \cdot {\sum }_{k = 1}^{{N}_{ch}} {I}_{ch} ( k ) \qquad [ Mathematical expression 8 ]$$

In mathematical expression 8, J is an objective function, τ_{ch}(k) is the charging time at the k-th charging station, ω is a weight for the total number of charging times, I_{ch}(k) indicates whether charging is performed at the k-th charging station, (for example, I_{ch}(k) is 1 when charging is performed at the k-th charging station and I_{ch}(k) is 0 when charging is not performed at the k-th charging station), and N_{ch} may represent the number of charging stations located on the driving route.

For example, the objective function of the charging planning model may include the first term for the total charging time and the second term for the total number of charging times.

The total charging time may be derived or determined as the sum of the charging times at one or more charging stations located on the driving route. The charging time at each charging station may be derived or determined based on the temperature, charge amount, and charge current of the battery.

The change in the charging current of the battery may be derived or determined based on the product of the charge change amount of the battery and the battery capacity. In addition, the change in the temperature of the battery may be derived or determined based on the product of the charging current, internal resistance, and battery specific heat of the battery. In addition, the change in the charge amount of the battery may be derived or determined based on the product of the charge amount and the temperature of the battery.

The charging plan information may include a charging station to perform charging among one or more charging stations located on the driving route, the charge amount, and the charging time.

The method of providing information for a vehicle (S200) may further include an operation of receiving importance information for each item of a plurality of items of the charging plan information.

In mathematical expression 8, the value of the weight for the total number of charges may be changed based on the importance information for each item of the plurality of items of the charging plan information.

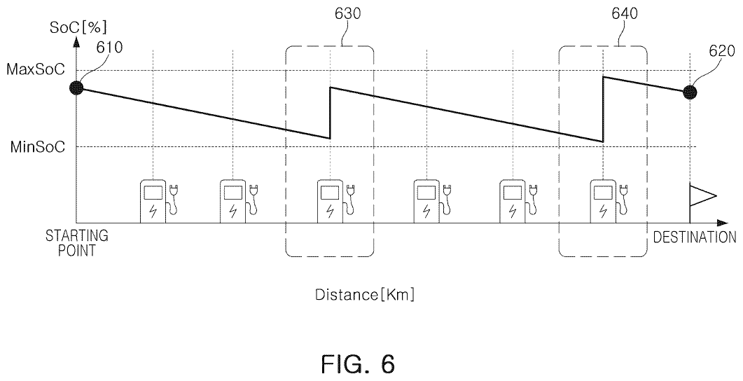

FIG. 6 illustrates the SoC of the battery when driving according to the charging plan information generated according to an embodiment by way of example. In FIG. 6, the SoC of the battery may have a value within the range of the minimum SoC and the maximum SoC of the battery.

From the initial SOC information 610 of the battery included in the vehicle, the SoC of the battery may decrease as the vehicle drives. The charging plan information may be generated using a charging plan model based on an objective function so that the target SoC information 620 at the destination input by the user may be achieved. The charging plan information may include a plurality of items, including a charging station to perform charging among one or more charging stations located on the driving route, a charging amount, and a charging time.

The example illustrated in FIG. 6 illustrates that charging is performed according to the charging plan information at two charging stations 630 and 640 among one or more charging stations located on the driving route.

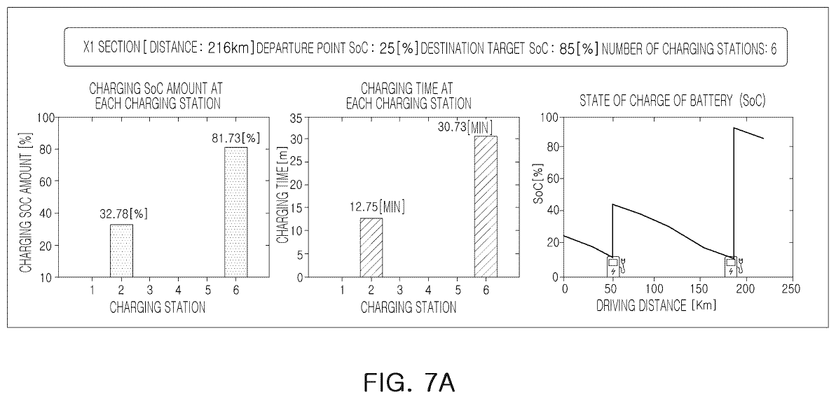

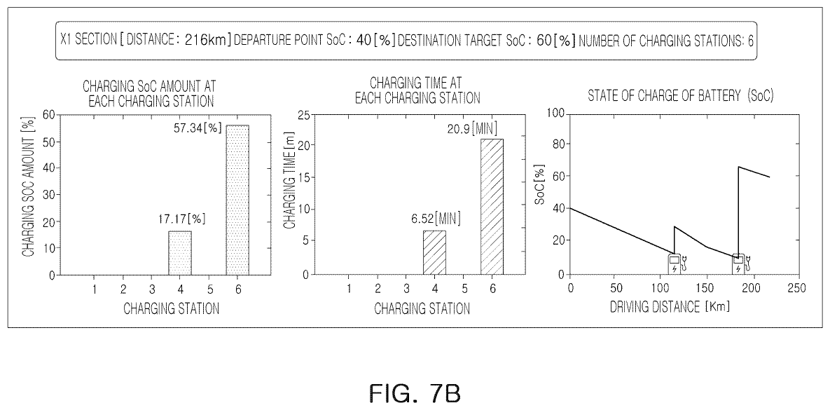

FIG. 7A and FIG. 7B illustrate display screens on which charging plan information generated by a method of providing information for a vehicle according to an embodiment is provided. The charging plan information may include a plurality of items, including a charging station to perform charging among one or more charging stations located on the driving route, a charging amount, and a charging time.

Comparing FIG. 7A and FIG. 7B, even for the charging plan information for the same X1 section (i.e., same unit section), if the initial SoC information at the starting point of the battery is different or the target SoC information at the destination is input differently, the charging plan information may be generated differently.

According to an embodiment of the present disclosure, charging plan information that is optimized for the driver and minimizes the charging time and the total driving time may be provided by using a charging plan model based on an objective function.

In addition, according to an embodiment of the present disclosure, the life of the battery may be extended and management efficiency may be improved, thereby providing convenience to the user, and environmental benefits may be obtained by improving energy consumption efficiency.

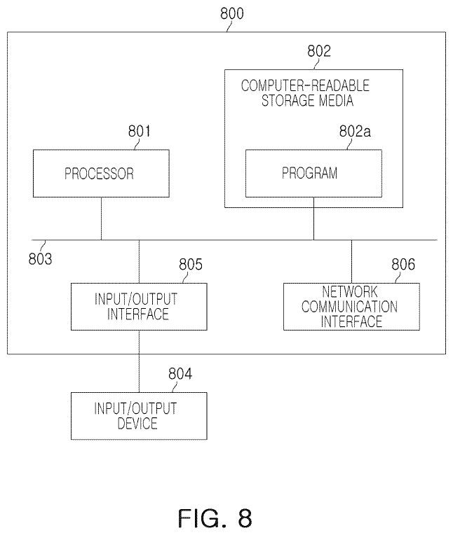

FIG. 8 is a block diagram of a computing device 800 that may fully or partially implement a vehicle system according to an embodiment, and may include all or part of the vehicle system 100 illustrated in FIG. 1.

As illustrated in FIG. 8, the computing device 800 includes at least one processor 801, a computer-readable storage medium 802, and a communication bus 803.

The processor 801 may cause the computing device 800 to operate according to the example embodiments mentioned above. For example, the processor 801 may execute one or more programs stored in the computer-readable storage medium 802. The one or more programs may include one or more computer-executable instructions, and the computer-executable instructions may be configured to cause the computing device 800 to perform operations according to the example embodiments when executed by the processor 801.

The computer-readable storage medium 802 is configured to store computer-executable instructions, program code, program data, and/or other suitable forms of data. The program 802a stored in the computer-readable storage medium 802 includes a set of instructions executable by the processor 801. In an embodiment, the computer-readable storage medium 802 may be memory (volatile memory, such as random access memory, nonvolatile memory, or a suitable combination thereof), one or more magnetic disk storage devices, optical disk storage devices, flash memory devices, or any other form of storage medium that may be accessed by the computing device 800 and capable of storing desired data, or a suitable combination thereof.

The communication bus 803 interconnects the various other components of the computing device 800, including the processor 801, the computer-readable storage medium 802.

The computing device 800 may also include one or more input/output interfaces 805 that provide an interface for one or more input/output devices 804, and one or more network communication interfaces 806. The input/output interfaces 805 and the network communication interfaces 806 are coupled to the communication bus 803.

The network communication interface 806 may include, for example, a Controller Area Network (CAN), a Media Oriented Systems Transport (MOST) network, a Local Interconnect Network (LIN), and/or X-by-Wire (Flexray), Wi-Fi, Bluetooth, Near Field Communication (NFC), Radio-Frequency Identification (RFID), and the like. The network may be a cellular network, for example, any one of a Global System for Mobile Communications (GSM), an Enhanced Data Rates for GSM Evolution (EDGE), a General Packet Radio Service (GPRS), a Code Division Multiple Access (CDMA), a Time Division (TD)-CDMA, a Universal Mobile Telecommunications System (UMTS), a Long Term Evolution (LTE), or any other cellular networks.

The input/output device 804 may be connected to other components of the computing device 800 via the input/output interface 805. Examples of input/output devices 804 may include input devices (or input modules) such as pointing devices (such as a mouse or trackpad), keyboards, touch input devices (such as a touchpad or a touchscreen), voice or sound input devices, various types of sensor devices and/or photographing devices, and/or output devices such as display devices, printers, speakers, and/or network cards. Illustrative input/output devices 804 may be included within the computing device 800 as a component constituting the computing device 800, or may be connected to the computing device 800 as a separate device distinct from the computing device 800.

Embodiments may include a program for performing the methods described herein on a computer, and a computer-readable recording medium including the program. The computer-readable recording medium may include program commands, local data files, local data structures, and the like alone or in combination. The medium may be specially designed and configured for the present disclosure, or may be commonly available in the field of computer software. Examples of computer-readable recording media include magnetic media such as hard disks, floppy disks, and magnetic tapes, optical recording media such as a Compact Disc-Read Only Memory (CD-ROM) and Digital Versatile Disc (DVD), and hardware devices specifically configured to store and execute program instructions such as a Read-Only Memory (ROM), Random Access Memory (RAM), and flash memory. Examples of such programs may include not only machine language codes such as those generated by a compiler, but also high-level language codes that may be executed by a computer using an interpreter or the like.

As set forth above, according to an embodiment, a method and apparatus for providing information for a vehicle, and a vehicle system including the apparatus or performing the method, may be provided, in which optimized charging plan information may be generated and provided using an objective function-based charging plan model to improve user convenience and energy consumption efficiency.

In an embodiment, a method and apparatus for providing information for a vehicle, and a vehicle system including the apparatus or performing the method, may be provided, in which the charging time and driving time may be shortened and the usability and management efficiency of a battery may be improved by generating and providing optimized charging plan information using an objective function-based charging plan model to a user.

In an embodiment, a method and apparatus for providing information for a vehicle, and a vehicle system including the apparatus or performing the method, may be provided, in which personalized charging plan information may be provided to a user.

In an embodiment, a method and apparatus for providing information for a vehicle, and a vehicle system including the apparatus or performing the method, may be provided, in which driving convenience and the overall road environment may be improved by generating and providing optimized charging plan information based on changing real-time traffic conditions and driving environment data.

While example embodiments have been shown and described above, it should be apparent to those having ordinary skill in the art that modifications and variations could be made without departing from the scope of the present disclosure as defined by the appended claims.

What is claimed is:

1. A method of providing information for a vehicle, performed by a computing device including a processor and a storage medium storing instructions executable by the processor, the method comprising:
receiving destination information of the vehicle and target State Of Charge (SoC) information of a battery of the vehicle at a destination;
collecting driving environment data on a driving route determined based on the destination information;
determining a charging plan establishment condition based on the target SOC information and the driving environment data; and
generating charging plan information using a charging plan model based on an objective function based on the charging plan establishment condition being satisfied.

2. The method of claim 1, wherein the driving environment data includes data on one or more charging stations located on the driving route, and
wherein generating the charging plan information includes determining the objective function of the charging plan model based on the data on the one or more charging stations located on the driving route.

3. The method of claim 2, wherein the charging plan information includes a charging station to perform charging among the one or more charging stations located on the driving route, a charging amount, and a charging time.

4. The method of claim 2, wherein the objective function is determined based on a total charging time and a total number of charging times for driving the driving route, and
wherein generating the charging plan information includes determining a lowest value solution of the objective function using the charging plan model, and generating the charging plan information based on the lowest value solution of the objective function.

5. The method of claim 4, wherein the total charging time is determined as a sum of at least one charging time at the one or more charging stations located on the driving route, and
wherein the at least one charging time at the one or more charging stations located on the driving route is determined based on a temperature, a charging amount, and a charging current of the battery.

6. The method of claim 2, wherein the objective function is determined based on mathematical expression 1:
$$J = {\sum }_{k = 1}^{{N}_{ch}} {τ}_{ch} ( k ) + ω \cdot {\sum }_{k = 1}^{{N}_{ch}} {I}_{ch} ( k ) ,$$
wherein in the mathematical expression 1, J is the objective function, τ_{ch}(k) is a charging time at a k-th charging station, ω is a weight for a total number of charging times for driving the driving route, I_{ch}(k) is 1 or 0 based on whether charging is performed at the k-th charging station, wherein I_{ch}(k) is 1 when charging is performed at the k-th charging station and I_{ch}(k) is 0 when charging is not performed at the k-th charging station, and N_{ch} represents a number of the one or more charging stations located on the driving route.

7. The method of claim 6, further comprising receiving importance information for each item of a plurality of items of the charging plan information,
wherein a value of the weight for the total number of charging times is changed based on the importance information for each item of the plurality of items of the charging plan information.

8. The method of claim 1, wherein determining the charging plan establishment condition includes:
determining a first sub-condition based on a total required charging amount for driving the driving route;
determining a second sub-condition based on minimum SoC information of the battery; and
determining a third sub-condition based on the target SoC information,
wherein, based on the first sub-condition, the second sub-condition, and the third sub-condition being satisfied, the charging plan establishment condition is determined as being satisfied.

9. An apparatus for providing information for a vehicle, the apparatus comprising:
a processor; and
a storage medium storing instructions executable by the processor,
wherein the processor, by executing the instructions, is configured to
receive destination information of the vehicle and target State Of Charge (SoC) information of a battery of the vehicle at a destination,
collect driving environment data on a driving route determined based on the destination information,
determine a charging plan establishment condition based on the target Soc information and the driving environment data, and
generate charging plan information using a charging plan model based on an objective function based on the charging plan establishment condition being satisfied.

10. The apparatus of claim 9, wherein the driving environment data includes data on one or more charging stations located on the driving route, and
wherein the processor is further configured to determine the objective function of the charging plan model based on the data on the one or more charging stations located on the driving route.

11. The apparatus of claim 10, wherein the charging plan information includes a charging station to perform charging among the one or more charging stations located on the driving route, a charging amount, and a charging time.

12. The apparatus of claim 10, wherein the processor is further configured to,
determine the objective function based on a total charging time and a total number of charging times for driving the driving route,
determine a lowest value solution of the objective function using the charging plan model, and
generate the charging plan information based on the lowest value solution of the objective function.

13. The apparatus of claim 12, wherein the processor is further configured to,
determine at least one charging time at the one or more charging stations located on the driving route based on a temperature, a charging amount, and a charging current of the battery, and
determine the total charging time as a sum of the at least one charging time at the one or more charging stations located on the driving route.

14. The apparatus of claim 10, wherein the processor is further configured to determine the objective function based on mathematical expression 1:
$$J = {\sum }_{k = 1}^{{N}_{ch}} {τ}_{ch} ( k ) + ω \cdot {\sum }_{k = 1}^{{N}_{ch}} {I}_{ch} ( k ) ,$$
wherein in the mathematical expression 1, J is the objective function, τ_{ch}(k) is a charging time at a k-th charging station, ω is a weight for a total number of charging times, I_{ch}(k) 1 or 0 based on whether charging is performed at the k-th charging station, wherein I_{ch}(k) is 1 when charging is performed at the k-th charging station and I_{ch}(k) is 0 when charging is not performed at the k-th charging station, and N_{ch} indicates a number of the one or more charging stations located on the driving route.

15. The apparatus of claim 14, wherein the processor is further configured to,
receive importance information for each item of a plurality of items of the charging plan information, and
change a value of the weight for the total number of charging times based on the importance information for each item of the plurality of items of the charging plan information.

16. The apparatus of claim 9, wherein the processor is further configured to
determine a first sub-condition based on a total required charging amount for driving the driving route,
determine a second sub-condition based on minimum SoC information of the battery,
determine a third sub-condition based on the target SoC information, and
determine that the charging plan establishment condition is satisfied based on all of the first sub-condition, the second sub-condition, and the third sub-condition being satisfied.

17. A vehicle system comprising:
a battery;
a display;
an input module; and
a processor configured to
cause the display to display a user interface for receiving destination information of a vehicle and target State Of Charge (SoC) information of the battery at a destination,
collect driving environment data on a driving route determined based on the destination information,
determine a charging plan establishment condition based on the target SoC information and the driving environment data,
generate charging plan information using a charging plan model based on an objective function based on the charging plan establishment conditions being satisfied, and
cause the display to display the charging plan information.

18. The vehicle system of claim 17, wherein the driving environment data includes data on one or more charging stations located on the driving route, and
wherein the processor is further configured to determine the objective function of the charging plan model based on the data on the one or more charging stations located on the driving route.

19. The vehicle system of claim 18, wherein the charging plan information includes a charging station to perform charging among the one or more charging stations located on the driving route, a charging amount, and a charging time.

20. The vehicle system of claim 17, wherein the processor is further configured to,
determine the objective function based on a total charging time and a total number of charging times for driving on the driving route,
determine a smallest value solution of the objective function using the charging plan model, and
generate the charging plan information based on the smallest value solution of the objective function.
